(19) United States
(12) Patent Application Publication
(10) Pub. No.: US 2025/0093665 A1
(43) Pub. Date: Mar. 20, 2025

(54) Electronic Devices With Environmental Sealing

(71) Applicant: Apple Inc., Cupertino, CA (US)

(72) Inventors: Dominic P Cincione, San Francisco, CA (US); Anthony S Montevirgen, Redwood City, CA (US); Teodor Dabov, San Francisco, CA (US); Christopher Patton, San Jose, CA (US); Carolyn A Youstra, San Francisco, CA (US)

(21) Appl. No.: 18/773,124

(22) Filed: Jul. 15, 2024

Related U.S. Application Data
(60) Provisional application No. 63/583,739, filed on Sep. 19, 2023.

(51) Int. Cl. G02B 27/01

(52) U.S. Cl. CPC G02B 27/0176; G02B 27/0172; G02B 2027/0154; G02B 2027/0178

(57) ABSTRACT

A head-mounted device may include display projectors and waveguides. The head-mounted device may have a head-mounted housing in which the display projectors and waveguides are mounted. The head-mounted housing may have a housing wall forming cavities containing the display projectors and waveguides. A moisture-impermeable cover may be used to cover and protect each of the display projectors. The cover may be formed from an elastomeric sock. The sock may have an opening that allows the display projector to emit image light that is received by a corresponding one of waveguides. Partitions may also be formed in the housing to block moisture and other contaminants. An elastomeric gasket or bellows serving as a partition may be used to separate a display projector cavity from a waveguide cavity.

This application claims the benefit of U.S. provisional application No. 63/583,739, filed Sep. 19, 2023, which is hereby incorporated by reference herein in its entirety.

### FIELD

This relates generally to electronic devices, and, more particularly, to sealing electronic devices to prevent dust and moisture intrusion.

### BACKGROUND

Electronic devices have sensitive components such as electrical and optical components. It can be challenging to prevent dust, moisture, and other contaminants from interfering with proper operation of such sensitive components.

### SUMMARY

A head-mounted device may include display projectors and waveguides. The head-mounted device may have a head-mounted housing in which the display projectors and waveguides are mounted. The head-mounted housing may have a housing wall forming cavities that contain the display projectors and waveguides. A moisture-impermeable cover may be used to cover and protect each of the display projectors. Each cover may be formed from an elastomeric sock. The sock may have an opening that allows the display projector to emit image light that is received by a corresponding one of waveguides.

If desired, partitions may be formed between cavities in the housing to block moisture and other contaminants. An elastomeric gasket or bellows serving as a partition may, for example, be used to separate a display projector cavity from a waveguide cavity.

Positioners may be used to dynamically align the display projectors with respect to the waveguides or adhesive may be used to attach the display projectors to the housing wall. A positioner may be coupled between the housing wall and a portion of the display projector that protrudes through the elastomeric sock or may be coupled to a structure such as a clamp that holds the display projector through the sock.

### BRIEF DESCRIPTION OF THE DRAWINGS

FIG. 1 is a top view of an illustrative electronic device in accordance with an embodiment.

FIG. 2 is a cross-sectional top view of a portion of an illustrative electronic device showing how a display projector may be protected using an elastomeric cover such as an elastomeric sock in accordance with an embodiment.

FIG. 3 is a cross-sectional side view of a portion of an elastomeric sock that has an opening through which an electrical signal path may pass in accordance with an embodiment.

FIG. 4 is a cross-sectional side view of an illustrative display projector that is partly covered by an elastomeric sock in accordance with an embodiment.

FIG. 5 is a cross-sectional side view of an illustrative display projector that has a protrusion and a corresponding elastomeric sock with structures that form a seal with the protrusion in accordance with an embodiment.

FIG. 6 is a cross-sectional side view of an illustrative display projector with an internal mount and internal positioning equipment in accordance with an embodiment.

FIG. 7 is a cross-sectional side view of an illustrative display projector covered with an elastomeric sock and clamp to grip the display projector and sock in accordance with an embodiment.

FIG. 8 is a cross-sectional side view of an illustrative display projector covered with an elastomeric sock that has a locally stiffened portion.

FIG. 9 is a cross-sectional side view of an illustrative display projector that is at least partly covered with multiple elastomeric cover structures in accordance with an embodiment.

FIG. 10 is a cross-sectional side view of an illustrative display projector and an associated elastomeric partition structure such as a gasket that may be used to help seal the display projector and partition interior volumes within an electronic device in accordance with an embodiment.

FIG. 11 is a cross-sectional side view of an illustrative elastomeric sock having an end portion that is being used to help partition an interior volume in an electronic device into separate chambers in accordance with an embodiment.

FIG. 12 is a cross-sectional side view of an interior portion of an illustrative electronic device in which a bellows structure has been used to partition an internal display projector cavity from another interior volume such as a waveguide cavity in accordance with an embodiment.

### DETAILED DESCRIPTION

Electronic devices such as mixed-reality glasses or other head-mounted devices may have sensitive components such as waveguides and displays. As an example, a pair of mixed-reality glasses may have display projectors that emit images into waveguides. The waveguides may convey the images to eye boxes in which a user's eyes are located so that the user may view computer-generated content mixed with real-world images that the user is viewing through the waveguides. The display projectors and waveguides may be mounted within interior volumes of a glasses housing. The glasses housing may, for example, have waveguide cavities and display projector cavities. These chambers may be filled with air and may be separated from the exterior environment by housing walls.

In some arrangements, there may be a risk that moisture or other contaminants such as dust particles could enter into the air-filled cavities of an electronic device such as the waveguide cavities and display projector cavities. Enhanced sealing for these cavities can be provided using sealing structures such as elastomeric socks, elastomeric partitions (e.g., bellows), and other sealing structures. By preventing moisture and dust intrusion using these sealing structures, potential damage to sensitive components such as waveguides and display protectors may be avoided.

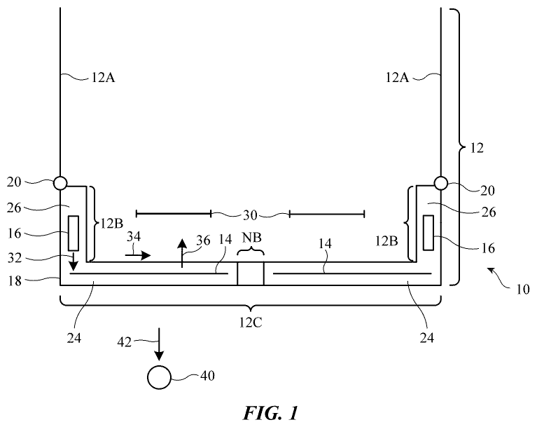

FIG. 1 is a top view of an illustrative electronic device of the type that may include sensitive components such as waveguides and display projectors. In the embodiment of FIG. 1, device 10 is a pair of mixed-reality glasses that may be provided with partitions, covers, and/or other sealing structures to help prevent damage to these sensitive components. Other type of electronic device 10 may be provided with sealing structures, if desired. The use of sealing structures in a pair of mixed-reality glasses is described herein as an example.

As shown in FIG. 1, device 10 may have a housing 12. Waveguides 14 and display projectors 16 may be mounted in housing 12. Housing 12, which may sometimes be referred to as a head-mounted housing, may be configured to be worn on a user's head. When device 10 is worn on the user's head, the user's eyes will be located in eye boxes 30. During operation, display projectors 16 may emit image light into waveguides 14 as shown by arrow 32. The image light corresponds to images to be displayed for the user. Waveguides 14 may transport these images into the center of device 10 as indicated by arrow 34. Output couplers on waveguides 14 (e.g., holographic output couplers) may then extract the guided images and directed the extracted images to eye boxes 30 for viewing by the user, as indicated by arrow 36. Waveguides 14 and any overlapping portions of housing portion 12C are transparent, so that the user may also view real-world objects such as object 40 through waveguides 14 in direction 42.

Housing 12, which may sometimes be referred to as a glasses frame, may have housing walls 18 formed from polymer, metal, ceramic, glass, and/or other materials. There is a potential for contaminants to pass through cracks in the housing walls (e.g., at joints between different portions of housing 12), so internal sealing structures such as elastomeric structures that are impervious to moisture may be used to help protect sensitive components.

Housing 12 may have optional hinges such as hinges 20 to connect elongated housing portions 12A on the sides of device 10 to housing portions 12B and 12C near front F of device 10. Housing portion 12C may extend entirely across front F of device 10 or may have left and right portions on the left and right of device 10 joined by nose bridge portion NB. Nose bridge portion NB may be configured to rest on a nose of a user when device 10 is worn on a user's head.

Waveguides 14 may be mounted in one or more internal waveguide cavities (chambers) 24 in housing portion 12C, so housing portion 12C may sometimes be said to form waveguide chamber portions of housing 12. Housing portion 12C may also sometimes be referred to as a front frame portion or front housing portion. Housing portions 12B may sometimes be referred to as temples or end pieces. Display projectors 16 may be mounted in internal display projector cavities 26 in housing portions 12B, so portions 12B may sometimes be said to form display projector cavity portions of housing 12.

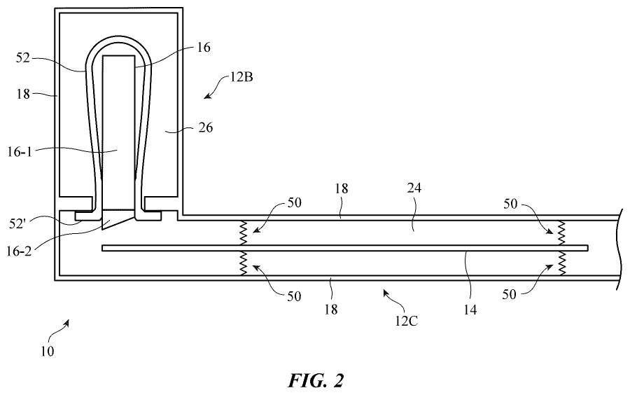

Display projectors 16 and waveguides 14 may be protected from contaminants (moisture, dust, etc.) using one or more flexible moisture-impermeable materials such as silicone or other elastomeric polymers (sometimes referred to as flexible polymers or elastomers). FIG. 2 is a cross-sectional top view of a portion of device 10 showing an illustrative sealing arrangement to cover and/or otherwise protect these components.

In the example of FIG. 2, waveguide 14 has been mounted in an air-filled waveguide cavity 24 in housing portion 12C. To help prevent contamination to the central portion of waveguide 14, elastomeric seals 50 may be formed at opposing ends of waveguide 14. Seals 50 may be configured to form bellows or other sealing structures and may extend between waveguide 14 and the inner surfaces of housing walls 18 in portion 12C. Due to the presence of seals 50, any moisture or other contaminants that enter device 10 at the ends of waveguide 14 will be blocked from traveling along the length of waveguide 14.

In housing portion 12B, there is a risk that moisture or other contaminants may pass through openings in housing wall 18 to reach display projector cavity 26. Accordingly, an elastomeric sealing structure such as elastomeric sock 52 may be placed around at least some of the exterior surfaces of display projector 16. Display projector 16 has display unit portion 16-1, which contains a projector that generates images and an image coupler portion such as prism portion 16-2 that is used in coupling image light for these images into waveguide 14. Images are output from display projector 16 at prism 16-2, so elastomeric sock 52 preferably has an opening aligned with prism 16-2 so as to not cover and block prism 16-2. During operation, image light may pass through this sock opening to waveguide 14. To seal off projector 16, portions 52′ of sock 52 may be attached to housing wall 18 of the display projector cavity formed by housing portion 12B (e.g., using adhesive, etc.).

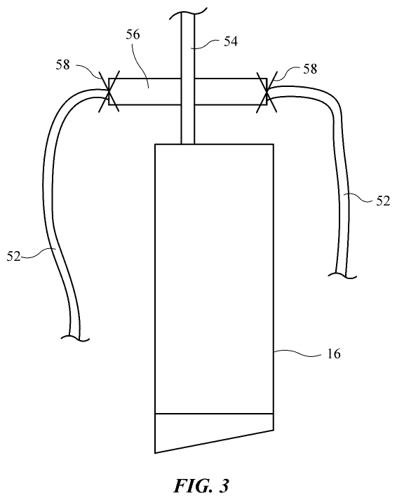

During operation of projector 16, it may be desirable to route power and data signals to projector 16. If desired, a signal cable may be routed to projector 16 through a signal cable opening in a portion of sock 52. This type of arrangement is shown in FIG. 3. In the example of FIG. 3, polymer sealing structure 56 (e.g., a flexible or rigid overmolded member, a gasket through which cable 54 has been passed, etc.) has been formed over cable 54. Structure 56 has then been placed in an opening in sock 52. At attachment points 58, crimp connections, adhesive, polymer welds, or other attachment mechanisms may be used to attach sock 52 to structure 56. Arrangements in which sock 52 is directly overmolded over cable 54 or in which cable 54 is sealed within an opening in sock 52 using only adhesive may also be used, if desired.

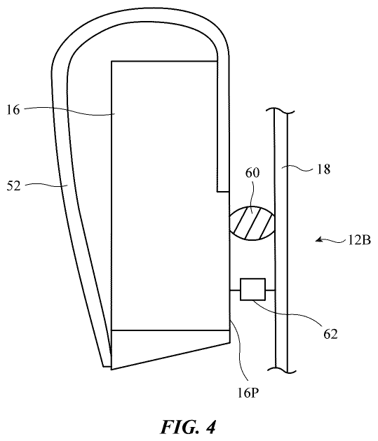

In some embodiments, sock 52 may only partly cover projector 16. This type of arrangement is shown in FIG. 4. In this example, moisture-sensitive surfaces of projector 16 have been covered and protected by sock 52, but portion 16P, which does not have any exposed moisture-sensitive areas, has been left uncovered by sock 52. This allows adhesive 60 to be used to attach projector 16 to housing wall 18. As an example, projector 16 may be aligned with respect to waveguide 14 using an assembly tool in a factory. Once aligned, adhesive 60 may be dispensed and cured to secure projector 16 in its aligned position. In another illustrative embodiment, adhesive 60 may be omitted, so that projector 16 may be dynamically repositioned during use of device 10. In particular, adhesive 60 may be omitted and an electrically adjustable positioner such as positioner 62 (e.g., a piezoelectric actuator, solenoid, motor, and/or other positioner) may be coupled between housing wall 18 in portion 12B and portion 12P of projector 16. In response to sensor measurements made during use of device 10, positioner 62 may be used to adjust the position of projector 16. Sock 52 may be formed from a flexible polymer (e.g., an elastomer) and may be sufficiently flexible to allow projector 16 to be moved by positioner 62. This arrangement allows projector 16 to be periodically realigned (e.g., after becoming misaligned due to a drop event, temperature-induced drift, etc.).

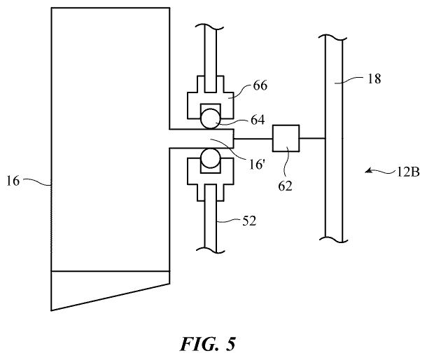

FIG. 5 shows another illustrative arrangement for coupling positioner 62 (or, if desired, adhesive 60 of FIG. 4) between housing wall 18 of portion 12B and a portion of projector 16. In the example of FIG. 5, projector 16 has a rigid projecting post or other portion 16′. Positioner 62 may be coupled between housing wall 18 and portion 16′, so that positioner 62 can periodically move projector 16 to align projector 16 with waveguide 14. Sock 52 can be sealed to portion 16′ using O-ring 64 and O-ring holder 66. Holder 66, which may be referred to as an O-ring support structure or grommet, may be attached to sock 52 using adhesive, polymer overmolding techniques, polymer welds, crimp connections, or other suitable attachment mechanisms. If desired, adhesive 60 (FIG. 4) may be coupled between wall 18 and portion 16′ rather than positioner 62.

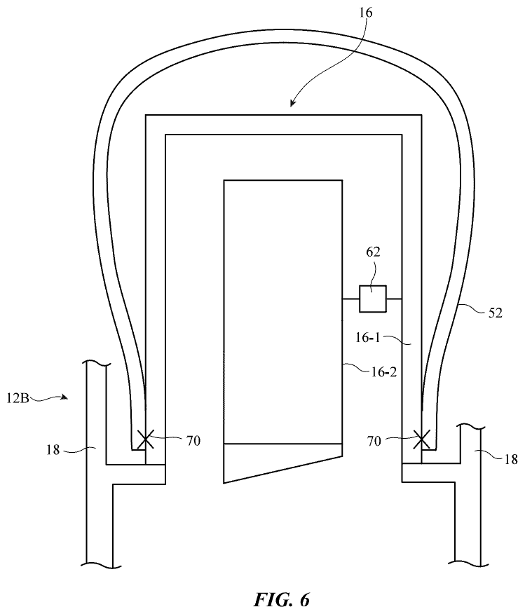

As shown in FIG. 6, projector 16 may have an outer shell portion 16-1 and a movable inner portion 16-2, which moves with respect to portion 16-1. Sock 52 may be attached and scaled around shell portion 16-1 using adhesive or other attachment mechanisms 70. This protects the outer surface of projector 16. During operation, positioner 62 may periodically adjust the position of inner portion 16-2 with respect to outer portion 16-1 (e.g., to align the projector).

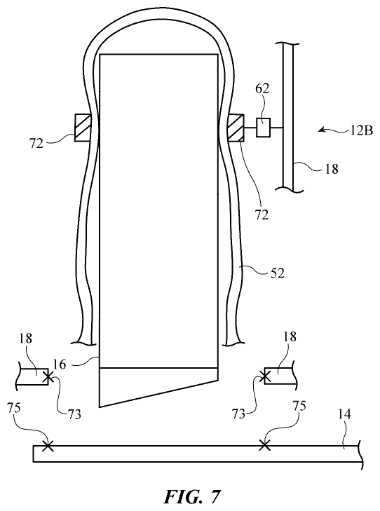

If desired, projector 16 may gripped through sock 52, without forming any additional openings in sock 52. This type of arrangement is shown in FIG. 7. As shown in FIG. 7, clamp 72 has been press fit over sock 52 and projector 16. This allows clamp 72 to firmly grip projector 16. Positioner 62 may be mounted between wall 18 of portion 12B and clamp 72, so that positioner 62 can adjust the position of projector 16 during operation. If desired, adhesive 60 (FIG. 4) may be coupled between wall 18 and clamp 72, rather than positioner 62. In the embodiment of FIG. 7 and other embodiments, the open end of sock 52 may be sealed against projector 16, may be sealed against wall 18 (see, e.g., illustrative sock attachment locations 73), or may be sealed against waveguide 14 (see, e.g., illustrative attachment locations 75).

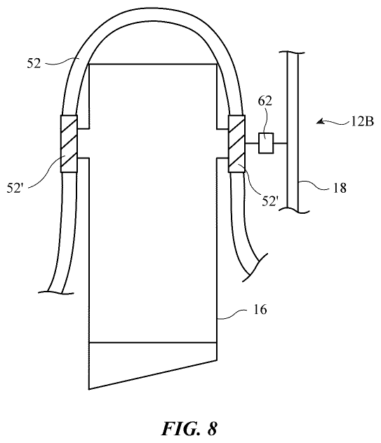

In the illustrative arrangement of FIG. 8, sock 52 has been provided with a rigid portion (rigid portion 52′, sometimes referred to as a locally stiffened portion). Portion 52′ may have a modulus of elasticity that is greater than that of the remaining flexible portions of sock 52. Portion 52′ may be attached to projector 16 using adhesive or other attachment mechanisms. Positioner 62 may be coupled between wall 18 of portion 12B and portion 52′ so that projector 16 can be positioned during operation of device 10 (e.g., to realign projector periodically). The flexible portions of sock 52 may extend over exposed portions of projector 16 to cover and protect projector 16 from moisture and other contaminants. Because portion 52′ is rigid, flexing of sock 52 where sock 52 is attached between positioner 62 and projector 16 may be minimized to help ensure that projector 16 can be positioned accurately. If desired, adhesive 60 (FIG. 4) may be used to attach rigid portion 52′ of sock 52 to wall 18, thereby rigidly attaching projector 16 to wall 18.

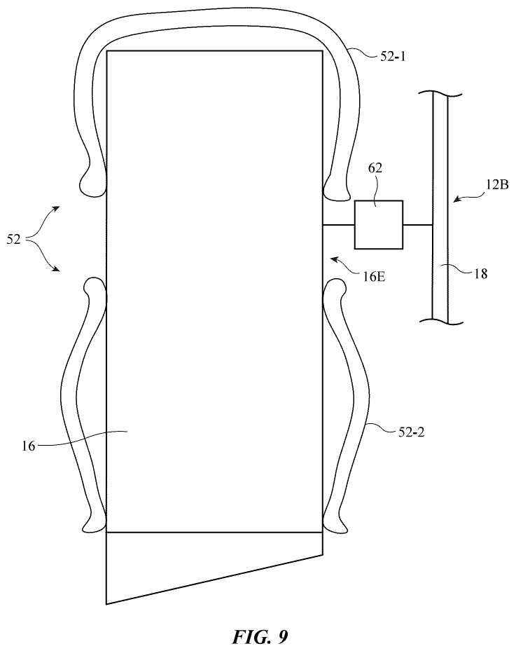

FIG. 9 shows how a cover such as sock 52 may be divided into multiple portions. In the example of FIG. 9, first sock portion (sock) 52-1 covers sensitive portions at the top of projector 16, whereas second portion 52-1, which has the shape of a tubular sleeve, covers sensitive portions at the bottom of projector 16. With this arrangement, portion 16E of projector 16, which is impervious to moisture, may be exposed. This allows positioner 62 to be coupled between wall 18 and portion 16E to allow projector 16 to be aligned during operation of device 10. If desired, adhesive 60 (FIG. 4) may be used to attach portion 16E to wall 18 in place of positioner 62, thereby rigidly attaching projector 16 to wall 18 in portion 12B.

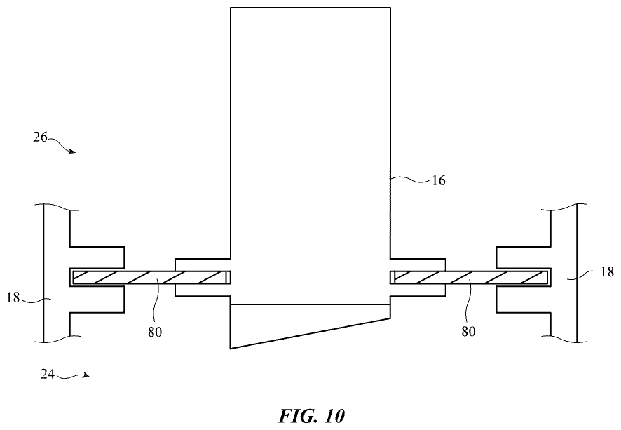

Another arrangement that may be used for preventing the intrusion of moisture or other contaminants in device 10 involves the use of partitioning seals (sometimes referred to as partitions or cavity divider structures). As shown in FIG. 10, for example, a ring-shaped elastomeric gasket such as gasket 80 may be connected to wall 18 at the prism end of projector 16. Adhesive, friction-fit connections, or other attachment mechanisms may be used to connect the outer edge of gasket 80 to wall 18 and to connect the inner edge of gasket 80 to projector 16. In this location, gasket 80 separates display projector cavity 26 from waveguide cavity 24, so gasket 80 forms an elastomeric partition between cavities 24 and 26. By partitioning the interior of housing 12 in this way, contaminants are prevented from moving between interior chambers of housing 12, thereby helping to protect the sensitive components in these chambers. Gasket 80 may be formed from an elastomeric material with a sufficiently low modulus of elasticity (e.g., sufficiently high flexibility) to allow display projector 16 to be moved during alignment operations.

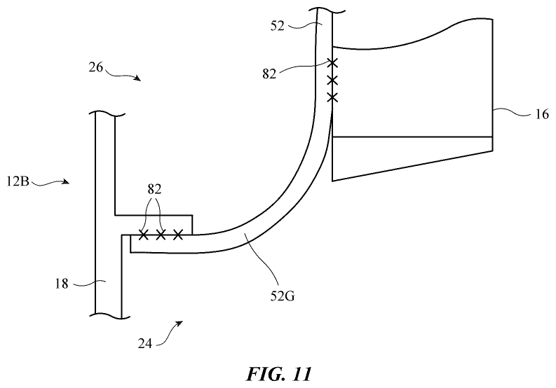

In the example of FIG. 11, portion 52G of elastomeric sock 52 is attached between wall 18 and the prism end of projector 16 using connections 82 (e.g., adhesive, friction-fit connections, and/or other attachment mechanisms). In this configuration, portion 52G serves as an elastomeric partition (e.g., portion 52G forms a partitioning seal that separates cavities 24 and 26).

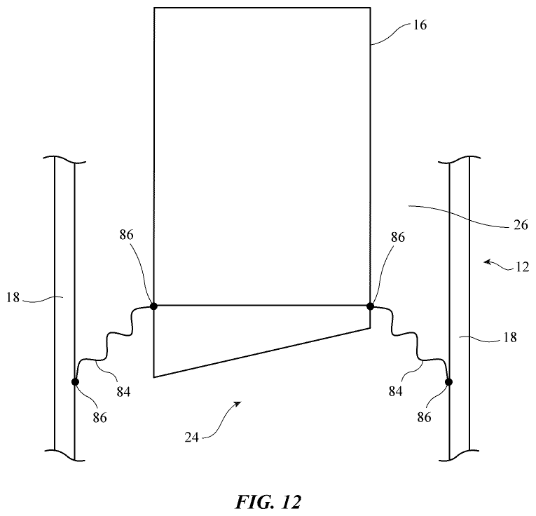

If desired, the flexibility of an elastomeric partition or other partitioning sealing structure may be enhanced using bellows. In the example of FIG. 12, the interior of housing 12 has been partitioned using a flexible partition formed from ring bellows 84. Bellows 84 separates cavity 24 from cavity 26 and thereby partitions the interior of housing 12. Bellows 84 may be attached between housing wall 18 and the prism end of projector 16 using adhesive, friction-fit connections, or other attachment mechanisms (see, e.g., connections 86).

Partitions such as bellows-based partitions or partitions formed from other flexible scaling structures (e.g., elastomeric gaskets, portions of sock 52, etc.) may be used in conjunction with elastomeric display projector covers such sock 52 or may be used separately.

To help protect the privacy of users, any personal user information that is gathered by device 10 may be handled using best practices. These best practices including meeting or exceeding any privacy regulations that are applicable. Opt-in and opt-out options and/or other options may be provided that allow users to control usage of their personal data.

The foregoing is merely illustrative and various modifications can be made to the described embodiments. The foregoing embodiments may be implemented individually or in any combination.

What is claimed is:

1. An electronic device, comprising:
a head-mounted housing;
a display projector in the head-mounted housing that is configured to emit image light;
a waveguide that is configured to receive the image light; and
an elastomeric cover configured to cover the display projector without blocking the image light.

2. The electronic device defined in claim 1 wherein the head-mounted housing has a housing wall configured to form first and second cavities.

3. The electronic device defined in claim 2 wherein the display projector and elastomeric cover are in the first cavity.

4. The electronic device defined in claim 3 wherein the elastomeric cover comprises an elastomeric sock that surrounds the display projector and wherein the elastomeric sock has an opening through which the image light passes.

5. The electronic device defined in claim 4 wherein a portion of the display projector passes through an additional opening in the elastomeric sock.

6. The electronic device defined in claim 5 further comprising adhesive configured to attach the portion of the display projector to the housing wall.

7. The electronic device defined in claim 5 further comprising a positioner coupled between the housing wall and the portion of the display projector, wherein the positioner is configured to dynamically adjust alignment of the display projector with respect to the waveguide.

8. The electronic device defined in claim 4 further comprising:
a clamp configured to hold the display projector through the elastomeric sock; and
a positioner coupled between the clamp and the housing wall.

9. The electronic device defined in claim 4 wherein the elastomeric sock has first and second portions and wherein the first and second portions have different elastic modulus values.

10. The electronic device defined in claim 4 further comprising a positioner inside the elastomeric sock that is configured to align the display projector.

11. An electronic device, comprising:
a head-mounted housing having a housing wall configured to form first and second cavities;
a display projector in the first cavity that is configured to emit image light;
a waveguide in the second cavity that is configured to receive the image light; and
a partition between the first and second cavities that is configured to block moisture.

12. The electronic device defined in claim 11 wherein the partition comprises a flexible bellows connected between the housing wall and the display projector.

13. The electronic device defined in claim 11 wherein the partition comprises an elastomeric gasket connected between the housing wall and the display projector.

14. The electronic device defined in claim 11 further comprising bellows coupled between the housing wall and the waveguide.

15. The electronic device defined in claim 11 further comprising an elastomeric sock that at least partly covers the display projector.

16. The electronic device defined in claim 15 wherein the elastomeric sock has a portion configured to form the partition.

17. An electronic device, comprising:
a head-mounted housing;
a display projector in the head-mounted housing that is configured to emit image light;
a waveguide that is configured to receive the image light; and
a sock configured to at least partly cover the display projector without blocking the image light.

18. The electronic device defined in claim 17 wherein the sock comprises an elastomeric material that is configured to block moisture.

19. The electronic device defined in claim 18 further comprising a signal cable configured to pass through the sock.

20. The electronic device defined in claim 18 further comprising a clamp configured to hold the display projector through the sock.
